(19) United States
(12) Patent Application Publication
(10) Pub. No.: US 2004/0098277 A1
(43) Pub. Date: May 20, 2004

(54) Licenses that include fields identifying properties

(75) Inventors: Bob Atkinson, Woodinville, WA (US); Brian A. LaMacchia, Seattle, WA (US); John DeTreville, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/298,829

(22) Filed: Nov. 18, 2002

(51) Int. Cl. G06F 17/60

(52) U.S. Cl. 705/1; 705/412

(57) ABSTRACT

A computer-implemented mechanism for granting rights to a resource is described. Trusted issuers and other entities may define properties and criteria for determining whether an entity possesses a property. A license may be used to assert that a principal possesses the property. A trusted issuer may then issue a second license that authorizes any entity that possesses the property the right to utilize a resource.

### FIELD OF THE INVENTION

The invention generally relates to the field of computer security and, more particularly, to digital licenses and related systems and methods that include fields describing elements in terms of properties they possess.

### BACKGROUND

Trust management languages and data structures are frequently used to grant principals rights to access digital data. Conventional trust management languages and data structures utilize licenses. A license typically identifies the issuer, the principal (such as a user), the right, the resource and any conditions. FIG. 1 illustrates a conventional mechanism for granting rights to access a resource 102. Resource 102 may be a digital work in the form of an image, an audio or video file, an e-book, or the like. When a trusted issuer 104 desires to grant principals 106, 108 and 110 access to resource 102, the trusted issuer must issue three separate licenses 112, 114 and 116. Each license identifies the principal 106, 108 or 110, resource 102, the right granted and any conditions.

There are several drawbacks to the mechanism of granting rights in the manner shown in FIG. 1. Even when each of principals 106, 108 and 110 already possess a common, defining property, such as being the members of a group, the trusted issuer must issue separate licenses to all of the members of the group. Some prior art trust management languages include a limited number of membership groups that can be used when granting rights to a resource. For example, a trust management language may allow a condition to be a function of whether or not a principal is female. When one using prior art trust management languages desires to identify a new group or describe a group of elements in terms of a new common property, the user must modify the trust management language in order to extend it. For example, to include condition statements that are a function of whether a principal possesses the particular property of working directly for a supervisor who is at least a vice president would involve extending and thus rewriting a trust management language. The modifications are inconvenient, can have unintended consequences, lead to errors, and limit the expressiveness of prior art trust management languages and data structures.

Therefore, there is a need in the art to extend trust management languages and data structures to provide a level of indirection so that elements may be semantically grouped together when they possess arbitrary properties or belong to groups defined by a trusted issuer, so that these semantic groupings may be used as conditions within licenses.

### SUMMARY

One or more of the above-mentioned needs in the art are satisfied by the disclosed authorization languages and data structures. The disclosed languages and data structures improve upon existing languages by allowing conditions and other fields to be functions of abstract or concrete properties possessed by principals or other entities. Trusted issuers and other entities may define the properties and criteria for determining whether an entity possesses the property. In one embodiment, a trusted issuer issues a first license to a principal. The first license grants the principal the right to possess the property. In other words, it certifies that the named principal possesses the named property. A trusted issuer then issues a second license that authorizes any entity that possesses the property the right to utilize a resource. The first license may be modified or revoked with out affecting the second license, and vice versa.

### BRIEF DESCRIPTION OF THE DRAWINGS

Aspects of the present invention are described with respect to the accompanying figures, in which like reference numerals identify like elements, and in which:

FIG. 1 illustrates a prior art mechanism for granting rights to access a resource;

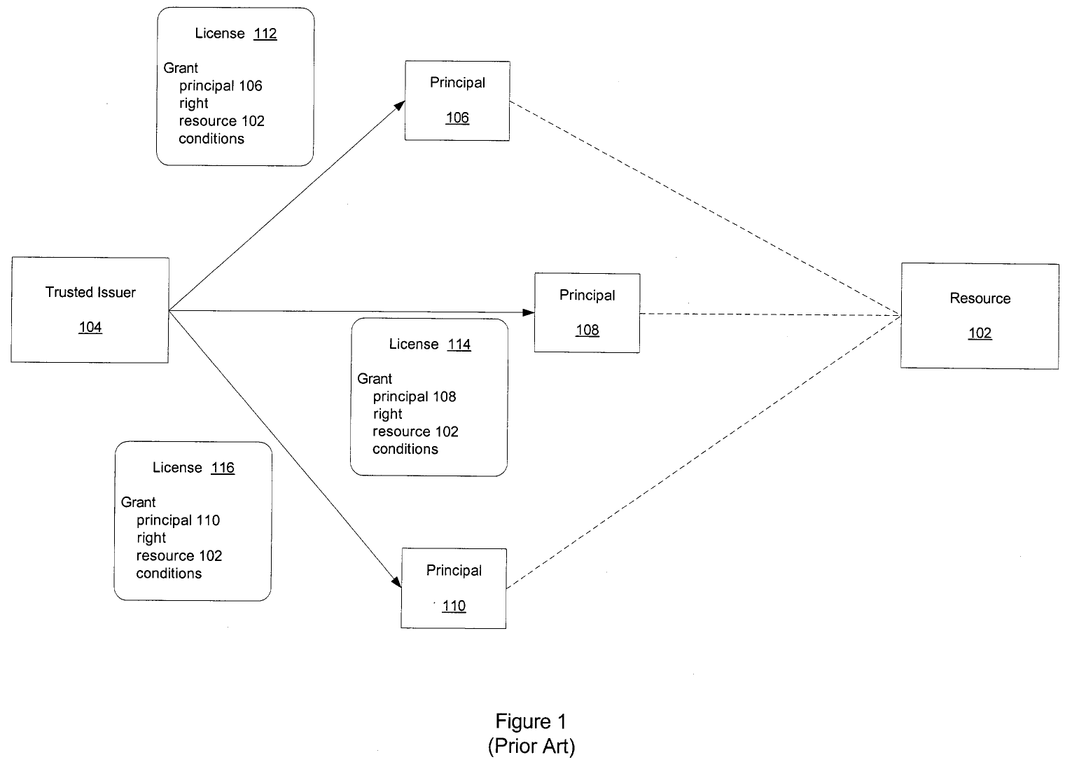

FIG. 2 shows an illustrative distributed computing system operating environment that may be used to implement aspects of the invention;

FIG. 3 illustrates a system for granting rights to a resource, in accordance with an embodiment of the invention;

FIG. 4 illustrates a method used by an access control module or parsing module in accordance with an embodiment of the invention; and

FIG. 5 illustrates a license data structure, in accordance with an embodiment of the invention.

### DETAILED DESCRIPTION

Exemplary Operating Environment

Aspects of the present invention are suitable for use in a distributed computing system environment. In a distributed computing environment, tasks may be performed by remote computer devices that are linked through communications networks. The distributed computing environment may include client and server devices that may communicate either locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or otherwise programmable consumer electronics, networked PCs, minicomputers, mainframe computers, and the like.

The invention will be described in the general context of computer-executable instructions, such as program modules, that are executed by a processing device, including, but not limited to a personal computer. Generally, program modules include routines, programs, objects, components, data structures, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

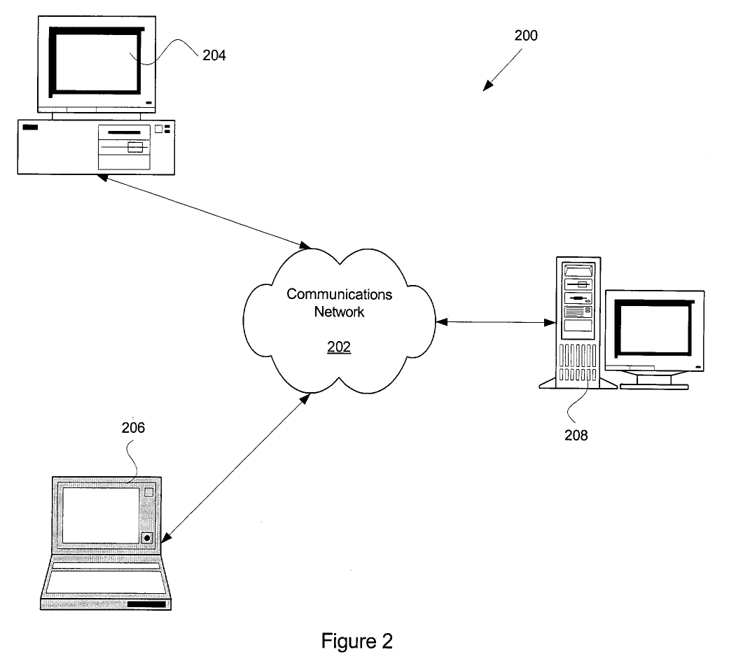

FIG. 2 illustrates an example of a suitable distributed computing system 200 operating environment in which the invention may be implemented. Distributed computing system 200 is only one example of a suitable operating environment and is not intended to suggest any limitation as to the scope of use or functionality of the invention. System 200 is shown as including a communications network 202. The specific network implementation used can be, for example, any type of local area network (LAN) and associated LAN topologies and protocols; simple point-to-point networks (such as direct modem-to-modem connection); and wide area network (WAN) implementations, including public Internets and commercial based network services such as the Microsoft Network or America Online's network. Systems may also include more than one communication network, such as a LAN coupled to the Internet.

Computer device 204, computer device 206 and computer device 208 may be coupled to communications network 202 through communication devices. Network interfaces or adapters may be used to connect computer devices 204, 206 and 208 to a LAN. When communications network 202 includes a WAN, modems or other means for establishing communications over WANs may be utilized. Computer devices 204, 206 and 208 may communicate with one another via communication network 202 in ways that are well known in the art. The existence of any of various well-known protocols, such as TCP/IP, Ethernet, FTP, HTTP and the like, is presumed. Computer devices 204, 206 and 208 may exchange content, applications, messages and other objects via communications network 202.

Description of Illustrative Embodiments

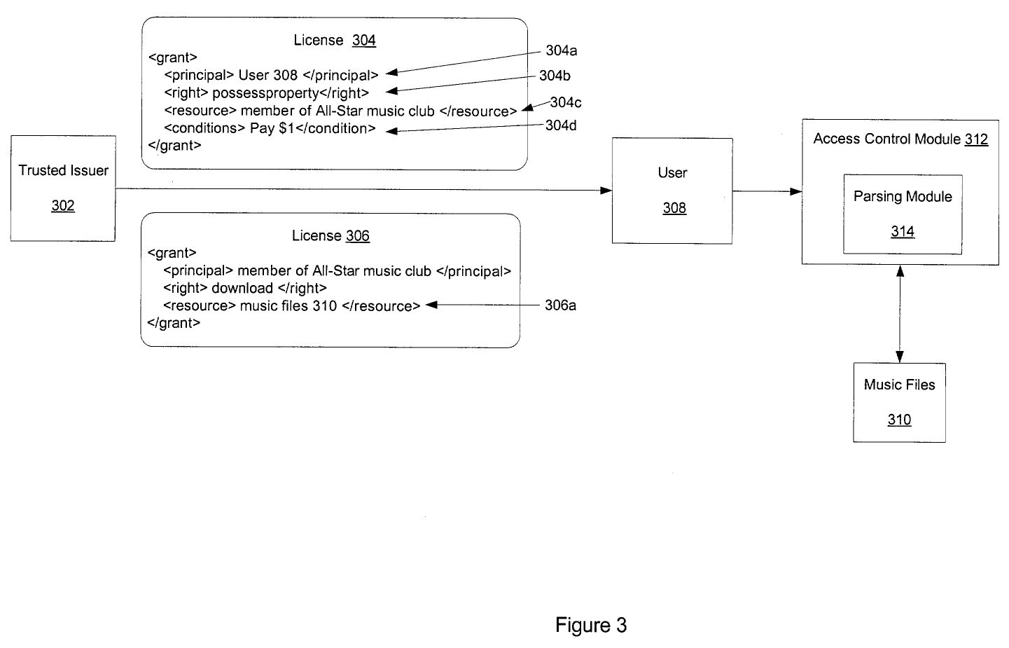

FIG. 3 illustrates a system for granting rights to a resource in accordance with an embodiment of the invention. For illustration purposes only the system shown in FIG. 3 relates to a music system. As one skilled in the art will appreciate, aspects of the present invention may be used in the implementation of a variety of other systems and methods. A trusted issuer 302 issues licenses 304 and 306 to a user 308. License 304 identifies user 308 as possessing the property of being a member of the “All-Star” music club. In particular, field 304a identifies the principal as user 308. Field 304b identifies the right as possessing a property. Field 304c identifies the resource as membership in the All-Star music club. A condition field 304d may also be included to identify any additional conditions. In one embodiment, a condition may include the possession of one or more other properties. In license 304, possessing the property of being a member of the All-Star music club is available to user 308 subject to the additional condition of payment of a $1 fee. Of course, numerous additional or alternative conditions may also be included.

License 304 asserts that user 308, having paid $1, possesses the property of being a member of the All-Star music club. License 306 grants all members of the All-Star music club the right to download music files 310. License 306 may be distributed to numerous entities who are or are not necessarily members of the music club. The resource identified in field 306a may identify a single music file, a group of music files or any other group specified by trusted issuer 302.

Licenses 304 and 306 may be expressed in a usage rights grammar language, including but not limited to logic-programming languages or eXtensible Markup Language (XML) derivatives, such as the eXtensible rights Markup Language (XrML), version 2.0. In other aspects of the invention, licenses 304 and 306 may be expressed as a data structure in a programming language. For example, object-oriented programming languages, including but not limited to C++, Java, Eiffel, C#, Objective C, and Common Lisp may be used to create, manipulate, and check data structures that express an authorization policy. Further, other programming languages may also be used to express an authorization policy, including but not limited to C and assembly language.

User 308 may transmit licenses 304 and 306 to an access control module 312. Access control module 312 may be a software or hardware module, residing locally or remotely to corresponding resource 310 and may be used to control access to resource 310. Access control module 312 may include a parsing module 314 to parse and interpret licenses. In one particular embodiment that uses licenses formatted in accordance with XrML schemas, parsing module 314 parses an XrML document to obtain license data. In alternative embodiments of the invention, one or more resources may include access control modules and/or parsing modules that perform the functions of access control module 312 and parsing module 314.

Music files 310 may be stored on a server connected to a wide area network, such as the Internet. Alternatively, music files 310 may be stored on the same device as access control module 312 and access control module 312 may be used to control the reproduction and/or distribution of music files 310.

With the system shown in FIG. 3, trusted issuer 302 may issue individual licenses, such as license 304, to assert that individual users possess a property, such as group membership. Then, trusted issuer 302 may issue another license, such as license 306, that grants entities possessing the property the right to access a resource. One of the advantages of aspects of the invention is that arbitrary properties may be selected by the trusted issuer when issuing licenses. For example, the trusted issuer 302 may later desire to restructure membership criteria so that there are four different levels of membership. Licenses may be reissued to individual users to assert that they possess the property of belonging to one of these four membership levels. Moreover, additional licenses asserting that a user possess a property may be issued after the issuance of licenses that grant entities that possess the property the right to a resource. In the example shown in FIG. 3, new licenses similar to license 304 may be issued to new members after license 306 has been issued and without affecting license 306.

The possession of a property may also be implied from other licenses. That is, it is not required that a principal possess a license that explicitly grants a right to assert the possession of a property. For example, if one license from an appropriate trusted issuer asserts that principal X has property A, and a second license from an appropriate trusted issuer asserts that any principal with property A also has property B, and a third license from an appropriate trusted issuer asserts that any principal with property B can also access resource R, then these licenses might be used together by an Access Control Module to infer that principal X can access resource R, even though no individual license asserts that principal X has property B.

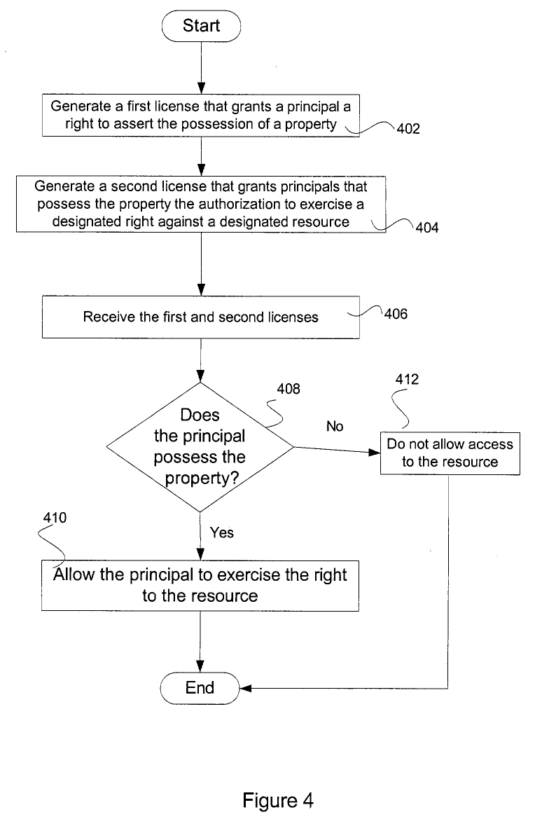

FIG. 4 illustrates a method of generating and processing licenses in accordance with an embodiment of the invention. First, in step 402 a trusted issuer generates a first license that asserts that a principal possesses the property. Next, in step 404 the trusted issuer generates a second license that grants principals that possess the property the authorization to exercise a designated right against a designated resource. First and second licenses are received in step 406. In one embodiment of the invention, the second license is transmitted from the trusted issuer directly to an access control module or resource while the first license is transmitted to the user. Alternatively, both licenses may first be transmitted to a user before being transmitted to an access control module or resource.

In step 408, an access control module or resource determines whether the principal possesses the property identified in the second license. Step 408 may include analyzing the first license. In alternative embodiments of the invention, no explicit first license from the trusted issuer is required to assert the possession of a property. The possession of the property may result from membership in a preexisting group, as a consequence of some other license or licenses independently issued, from some other characteristic that a principal possesses or due to some other mechanism that does not require the issuance of a license. When the principal possesses the property, in step 410, the principal is allowed to exercise the right to the resource identified in the second license. When the principal does not possess the property, in step 412, the principal is not allowed access to the resource.

The present invention is not limited to embodiments that involve the distribution or playing of musical content. In alternative embodiments of the invention, aspects of the present invention may additionally be used to grant rights to entities based on relationships between entities. For example, a secretary may have access to certain documents stored on a server when the secretary's boss is at least a vice president within the company.

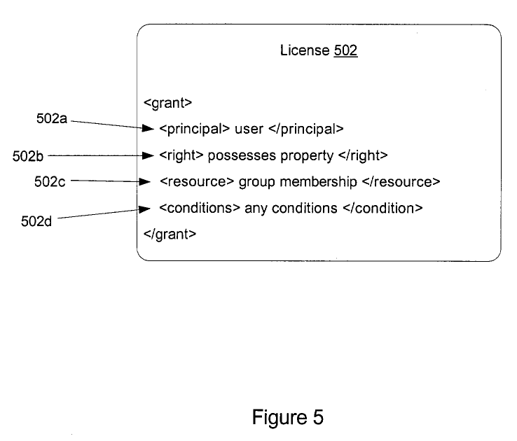

FIG. 5 illustrates a license data structure 502 in accordance with an embodiment of the invention. A first field 502a identifies the principal. A second field 502b identifies a right. In the example shown, the right comprises an assertion that an entity possesses a property. As has been described above, one implementation involves asserting that users possess the property of being a member of a group. The scope of the group may be defined by the issuer of license 502 and is not limited to groups that are defined by a trust management language. The field 502c may be included to identify the resource. In the example shown, the resource relates to group membership. Other properties that may be included in the resource field include gender, age, title within an organization, relationships between entities, pay grade and the like.

A field 502d may be included to identify one or more additional conditions that must be satisfied before the right identified in field 502b is effective. Exemplary conditions include expiration dates, payment requirements, authentication procedures, possession of another property or any other conditions identified by the issuer of license 502. License 502 will typically be signed by a trusted issuer to ensure the authenticity of license 502.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A computer-implemented method of processing at least two licenses to grant rights to a resource, the method comprising:
(a) receiving a first license that grants a first principal a right to possess a property;
(b) receiving a second license that grants principals that possess the property a right to a resource;
(c) determining whether a second principal possess the property; and
(d) granting the second principal the right to the resource when the second principal possesses the property.

2. The computer-implemented method of claim 1, wherein the first principal is the same as the second principal.

3. The computer-implemented method of claim 1, wherein (c) comprises analyzing the first license.

4. The computer-implemented method of claim 1, wherein the property comprises membership in a group.

5. The computer-implemented method of claim 1, wherein the property is defined by a trusted issuer of the first license.

6. The computer-implemented method of claim 1, wherein the first license is formatted in accordance with a trust management language and the property is not defined by the trust management language.

7. The computer-implemented method of claim 1, wherein the second license includes a condition and (d) comprises granting the second principal the right to the resource only when the condition is satisfied.

8. The computer-implemented method of claim 7, wherein the condition comprises payment of a fee.

9. The computer-implemented method of claim 1, wherein the first license includes a condition and (c) comprises determining whether the condition is satisfied.

10. The computer-implemented method of claim 9, wherein the condition comprises payment of a fee.

11. The computer-implemented method of claim 9, wherein the condition comprises the possession of another property.

12. The computer-implemented method of claim 1, wherein the first license is formatted in accordance with a trust management language that is a derivation of XML.

13. The computer-implemented method of claim 1, wherein the first license is formatted in accordance with a computer programming language.

14. The computer-implemented method of claim 1, wherein the right includes a right to the resource comprises a right to download a digital file.

15. The computer-implemented method of claim 1, wherein the first license and the second license are created at different times.

16. The computer-implemented method of claim 1, wherein the resource comprises a group of elements.

17. A computer-implemented method of granting a principal a right to a resource, the method comprising: generating a first license that asserts that a principal possess a property; and generating a second license that grants principals that possess the property the right to the resource.

18. The computer-implemented method of claim 17, wherein the first license is formatted in accordance with a trust management language and the property is not defined by the trust management language.

19. The computer-implemented method of claim 17, wherein the first license is formatted in accordance with a trust management language.

20. The computer-implemented method of claim 19, wherein the trust management language is a derivation of XML.

21. The computer-implemented method of claim 19, wherein the license is created with a computer programming language.

22. A computer-readable medium having stored thereon a license data structure, said license data structure comprising:
a first field identifying a principal;
a second field identifying a right to possess a property; and
a third field identifying the property.

23. The computer-implemented method of claim 22, where the second field further includes an identification of one or more entities that the property is possessed relative to.

24. The computer-readable medium of claim 22, wherein the license data structure further includes:
a fourth field identifying at least one condition that must exist prior to the principal exercising the right to possess the property.

25. A computer-implemented method of processing a license that grant rights to a resource, the method comprising:
(a) receiving a license that grants principals that possess a property a right to a resource;
(b) determining whether it is implied that a principal possess the property; and
(c) granting the principal the right to the resource when it is implied that the principal possesses the property.

25. The computer-implemented method of claim 25, wherein (b) comprises analyzing one or more additional licenses possessed by the principal.
